(19) United States
(12) Patent Application Publication
(10) Pub. No.: US 2013/0206256 A1
(43) Pub. Date: Aug. 15, 2013

(54) BIASED SWING CHECK VALVE

(71) Applicant: Bray International, Inc., (US)

(72) Inventors: Serge Trudel, Houston, TX (US); Robert Dicaire, Boucherville (CA); antonio Maltese, Montreal (CA); Elie Banon, St. Laurent (CA)

(73) Assignee: Bray International, Inc., Houston, TX (US)

(21) Appl. No.: 13/674,597

(22) Filed: Nov. 12, 2012

Related U.S. Application Data
(60) Provisional application No. 61/558,273, filed on Nov. 10, 2011.

(51) Int. Cl. F16K 15/03

(52) U.S. Cl. CPC F16K 15/033
USPC 137/527; 137/14

(57) ABSTRACT

The disclosure relates to a check valve having a housing, a connector mounted inside the housing, a flapper joined to the connector, and a biasing member joined to the connector at one end and joined to the flapper proximate another end. The biasing member is internal to the housing, and includes a compression spring.

### CROSS-REFERENCE TO RELATED APPLICATIONS

This application claims the benefit of U.S. Provisional Application No. 61/558,273 filed on Nov. 10, 2011.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Valves may be used in a number of applications to control the flow of fluids through piping systems. There are several different types of valves used for controlling flow such as ball valves, gate valves, check valves, and the like. Check valves are configured to allow flow in the piping system in one direction only. For example, a check valve may be used proximate the discharge piping of a compressor or pump. The check valve on the discharge piping would allow the discharged fluid to flow past the check valve, while preventing fluid from flowing in the other direction toward the compressor and/or pump. Therefore, the check valve may protect the compressor or pump from any surges in downstream pressure, or backpressure.

Typically compressor check valves use gravity to close a flap in the valve. When the compressor is pushing fluid out of the compressor, the fluid pressure overcomes the force of gravity and moves the flapper thereby opening the flow path through the check valve. When the compressor stops pushing fluids, the pressure in the downstream piping drops and gravity may be allowed to close the flapper on the check valve. These types of check valves are only effective for use in horizontal piping runs. Further, in order to adjust the closing force on the flapper, the weight of the flapper must be changed.

### BRIEF SUMMARY

A need exists for an improved check valve for use in conjunction with compressors. There is a further need for a check valve that may be used at any valve orientation between the horizontal and the vertical that may operate over duration of one million cycles.

These objectives may be met with a biased check valve having a flapper and a biasing member. The biasing member may bias the flapper toward the closed position. More specifically, the disclosure relates to a check valve having a housing, a connector mounted inside the housing, a flapper joined to the connector, and a biasing member joined to the connector at one end and joined to the flapper proximate another end. The biasing member is internal to the housing, and includes a compression spring.

### BRIEF DESCRIPTION OF THE DRAWINGS

FIG. 1 depicts a schematic of a compressor piping system having a biased check valve.

FIG. 2 depicts a cross-sectional view of the biased check valve of FIG. 1 according to one embodiment.

FIG. 3A depicts a cross-sectional view of the biased check valve according to an embodiment in which the biased check valve is mounted at an oblique orientation in-between the vertical and the horizontal.

FIG. 3B depicts a cross-sectional view of the biased check valve according to an embodiment in which the biased check valve is mounted at a vertical orientation.

### DETAILED DESCRIPTION OF EMBODIMENT(S)

The description that follows includes exemplary apparatus, methods, techniques, and/or instruction sequences that embody techniques of the inventive subject matter. However, it is understood that the described embodiments may be practiced without these specific details.

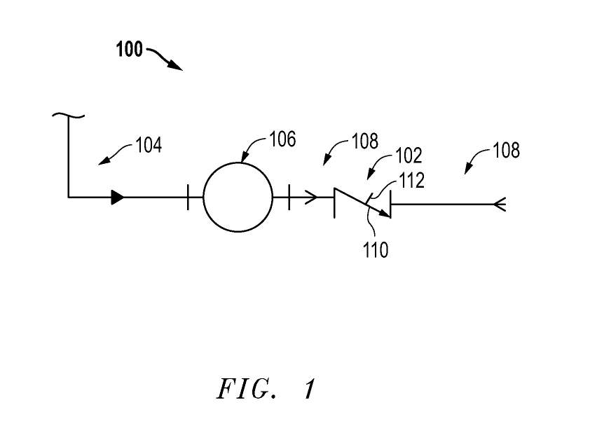

FIG. 1 depicts a schematic view piping system 100 having a biased check valve 102 according to an embodiment. The piping system 100 has a suction pipe 104, a compressor 106, and discharge pipe 108. The suction pipe 104 delivers fluids to the compressor 106. The compressor 106 then increases the flow rate and/or pressure of the fluids in the compressor 106 and pushes the fluids into the discharge pipe 108. The biased check valve 102 may be located in the discharge piping 108 (FIG. 1 shows discharge piping 108 connected to the inlet of the biased check valve 102 and discharge piping 108 connected to the outlet of the biased check valve 102) to prevent damage to the compressor 106 caused by back pressure, or increased pressure downstream of the compressor 106.

The biased check valve 102 may have a flapper 110 and a biasing member 112. The biasing member 112 may bias the flapper 110 toward the closed position. Therefore, when no pressure is present in the discharge pipe 108, the biasing member 112 may close the flapper 110 thereby preventing flow toward the compressor 106. The biasing member 112 may be any suitable biasing member for biasing the flapper 110 toward the closed position including, but not limited to, a coiled spring, a leaf spring, and the like. In the currently preferred embodiment, the biasing member 112 is a compression spring 228. The flapper 110 may be any suitable device for preventing back flow through the biased check valve 102.

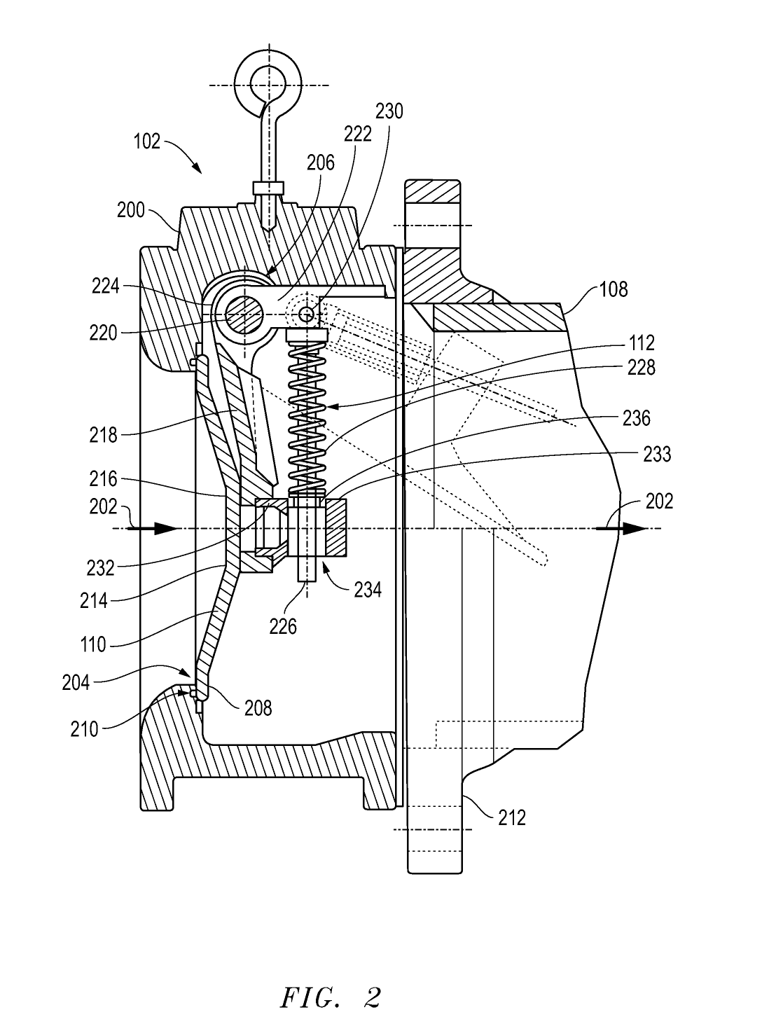

FIG. 2 depicts one embodiment of the biased check valve 102 of FIG. 1 shown in a cross-sectional view. The biased check valve 102 has a housing 200, a flow path 202, a valve seat 204, the flapper 110, a connector 206, and the biasing member 112. It is critical that the biased check valve 102 be self-contained (i.e. having all working parts, including biasing power, in an enclosed unit) in that the valve seat 204, the flapper 110, the connector 206, and the biasing member 112 are all internal to the housing 200. The biased check valve 102 is shown in the closed position. In the closed position, a sealing edge 208 of the flapper 110 engages the valve seat 204 thereby sealing the flow path 202. The valve seat 204 may have an O-ring 210, or similar sealing device, to enhance the seal between the flapper 110 and the valve seat 204. The O-ring 210 may be made of any suitable material including, but not limited to, an elastomer, polytetrafluoroethene sold under for example, the brand name TEFLON, and the like. In the closed position the biasing member 112 maintains a biasing force on the flapper 110 in order to keep the flapper in the closed position. The biased check valve 102 will remain in the closed position until fluid pressure upstream of the biased check valve 102 is increased to overcome the biasing force. When the biasing force is overcome, the fluid pressure compresses the biasing member 112 and moves the flapper 110 to the open position (an open position is represented by dashed lines in FIG. 2).

The housing 200 may be any suitable housing for securing the flapper 110 in the biased check valve 102. As shown, the housing 200 is configured to secure to a slip-on-flange 212. The slip-on-flange 212 may avoid interference with the compression spring 228 in the fully open position.

The flapper 110 may be any suitable device for sealing the flow of fluids through the flow path 202. As shown, the flapper 110 is a mono-disc type flapper. The flapper 110 may have a concave portion 214 radially inward from the sealing edge 208. An apex 216 of the flapper 110 may be configured to couple to an arm 218. The arm 218 may be configured to move the flapper 110 between the open and closed position, as will be discussed in more detail below. The arm 218 as shown is coupled to the downstream side of the apex 216 of the flapper 110. The arm 218 may be coupled to the flapper 110 using any suitable method including, but not limited to, welding, bolting, pinning, screwing, and the like. Although the flapper 110 is shown as a monodisc type flapper having an arm 218 for moving the flapper between the open and closed position, any suitable arrangement for sealing and opening the flow path 202 may be used.

The connector 206 may be configured to couple the arm 218 and/or the flapper 110 to the housing 200. In addition, the connector 206 may couple the biasing member 112 to the housing 200. As shown, the connector 206 is a hinge type connector that allows the arm 218 and thereby the flapper 110 to rotate about a pin 220. The connector 206 may have a fixed hinge 222 that couples to the interior of the housing 200 and a rotating hinge 224 that couples the connector 206 to the arm 218. Therefore, the rotating hinge 224 and arm 218 and/or flapper 110 may rotate between the open and closed position as the fixed hinge 222 remains in a stationary position in the housing 200. As shown and preferably the axial direction of the pin 220 (and hence the fixed hinge 222 and the rotating hinge 224) is oriented perpendicular to the direction of flow through the flow path 202.

The fixed hinge 222 may couple to the biasing member 112 in an embodiment. As shown, the biasing member 112 has a spring rod 226 for supporting the compression spring 228. The spring rod 226 may rotationally couple to the fixed hinge 222, and/or the housing 200, via a spring pin 230. The spring pin 230 may allow the spring rod 226 and the compression spring 228 to rotate between the open and closed position as the flapper 110 moves in the biased check valve 102. The spring rod 226 may further guide the compression spring 228 as the compression spring 228 is compressed between the open and closed position. Therefore, the spring rod 226 may prevent the misalignment and/or deformation of the compression spring 228 during the life of the biased check valve 102. The biasing member 112 may be configured to prevent the compression spring 228 from stressing beyond its elastic limit, thereby extending the life of the biasing member 112.

A nut 232 may couple the biasing member 112 to the flapper 110. As shown, the nut 232 couples to the arm 218 proximate the apex 216 of the flapper 110. The nut 232 may couple to the arm 218 using any suitable method including, but not limited to, a threaded connection, a pin, a weld and the like. The nut 232 may have an aperture 234 configured to receive the spring rod 226. The nut 232 may further have a shoulder/bushing 236 configured to engage the compression spring 228. The compression spring 228 biases the shoulder 236 and thereby the flapper 110 toward the closed position. As the flapper 110 moves from the closed position to the open position, the spring rod 226 translates through the aperture 234. In addition, the shoulder 236 compresses the compression spring 228 thereby increasing the biasing force in the biasing member 112.

A top 233 of the nut 232 may engage the discharge/downstream pipe 108 and/or the housing 200 in the fully open position. The top 233 of the nut 232 may prevent the biasing member 112 and/or the flapper 110 from being damaged in the open position by acting as a stopper.

The size of the compression spring 228 may be adjusted to accommodate the type of service in which the biased check valve 102 is used. For example, a coiled spring having a higher biasing force may be used in higher pressure services and a coiled spring with a lower biasing force may be used in lower pressure services. Therefore, the biasing force in the biased check valve 102 may be adjusted without the need to replace the flapper 110 with a heavier flapper. This allows for improved sealing of the biased check valve 102 at low and/or negative pressures.

The weight of the flapper 110 or mass of the flapper 110 material may be adjusted to improve operation and the duration of operation of the biased check valve 102. The flapper 110 may in one embodiment be made of stainless steel in conformance with ASTM A351-CF8M specifications. The friction between spring rod 226 and the compression spring 228 may also be reduced by coating the spring rod 226 with a material reducing or having a lower coefficient of friction, such as for example, polytetrafluoroethene sold under the brand name TEFLON. Friction may likewise be reduced in the connector 206. Although the biasing member 112 is shown as a compression spring 228 supported by a spring rod 226, the biasing member 112 may be any suitable device(s) including, but not limited to, a leaf spring, an accumulator, and the like.

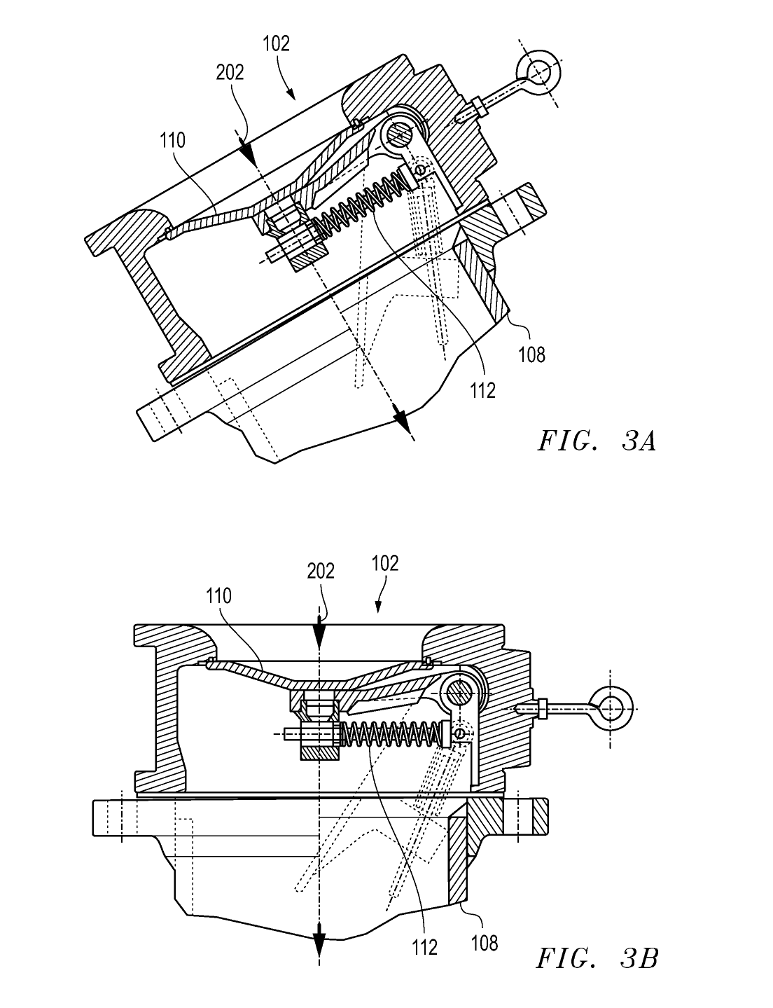

The biased check valve 102 may be installed in the piping system 100 in any valve orientation including one at which the flow path 202 is in a vertical orientation (e.g. see FIG. 3B) a horizontal orientation (e.g. see FIG. 2) and any oblique orientation, i.e. in-between the vertical and the horizontal (e.g. see FIG. 3A). It is in fact critical that the check valve 102 be operable in orientations in which the flow path is vertical or oblique to the horizontal as determined at any given installation site. The biased check valve 102 may increase the life of the valve by controlling the movement of the flapper 110 in the valve. Preferably, the biased check valve 102 in combination with the compressor 106 and mounted at any orientation will operate over a duration of at least six-hundred thousand cycles and, most preferably, one million cycles or greater.

While the embodiments are described with reference to various implementations and exploitations, it will be understood that these embodiments are illustrative and that the scope of the inventive subject matter is not limited to them. Many variations, modifications, additions and improvements are possible. For example, the implementations and techniques used herein may be applied to any one way valve in multiple types of piping systems, for example pump systems.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A check valve apparatus, comprising:
a housing;
a connector mounted inside the housing;
a flapper joined to the connector;
a biasing member joined to the connector at one end and joined to the flapper proximate another end;
wherein the biasing member is internal to the housing; and
wherein the biasing member comprises a compression spring.

2. The apparatus according to claim 1, wherein the connector comprises:
a fixed hinge attached inside the housing;
a pin joined to the fixed hinge;
a rotating hinge coupled to the pin; and
an arm joined to the rotating hinge at a first end and connected to the flapper proximate a second end.

3. The apparatus according to claim 2, wherein the biasing member further comprises a spring rod pinned at an end to the fixed hinge and slidably engaged by the flapper at another end; and wherein the compression spring is mounted over the spring rod.

4. The apparatus according to claim 3, wherein the flapper further comprises:
a nut connected to the flapper; and
a bushing attached to the nut, wherein the bushing defines an aperture configured to receive the spring rod and to shoulder the compression spring.

5. The apparatus according to claim 4, wherein the flapper further comprises a top attached to the bushing and protruding on a side of the spring rod opposite from the flapper in a direction proximately perpendicular to an axial direction of the spring rod.

6. The apparatus according to claim 5, wherein the top is configured to interfere with a discharge pipe connected to an outlet from the housing prior to any interference between the compression spring and the discharge pipe.

7. The apparatus according to FIG. 6, wherein an axial direction of the pin, the fixed hinge and the rotating hinge is perpendicular to a direction of flow through a flow path defined by the housing.

8. The apparatus according to claim 7, wherein the biasing member and the flapper are configured to cycle for at least six-hundred thousand cycles.

9. The apparatus according to claim 7, further comprising:
a suction pipe;
a compressor connected to the suction pipe;
another discharge pipe connected to the compressor; and
wherein an inlet to the housing of said check valve apparatus is connected to the other discharge pipe.

10. The apparatus according to claim 9 wherein said check valve apparatus is installed with the flow path in an orientation in which the flow path is oblique.

11. The apparatus according to claim 9 wherein said check valve apparatus is installed with the flow path in an orientation in which the flow path is vertical.

12. The apparatus according to claim 9, wherein the biasing member and the flapper are configured to cycle for at least six-hundred thousand cycles.

13. A check valve apparatus, comprising:
a housing defining a flow path through the housing;
a connector mounted inside the housing;
a flapper joined to the connector;
a biasing member joined to the connector at one end and joined to the flapper proximate another end;
wherein the biasing member is internal to the housing;
wherein the biasing member comprises a compression spring; and
wherein said check valve apparatus is installed with the flow path in an orientation in which the flow path is not horizontal.

14. The apparatus according to claim 13 wherein said check valve apparatus is installed with the flow path in an orientation in which the flow path is oblique to the horizontal.

15. The apparatus according to claim 14, wherein the connector comprises a fixed hinge attached inside the housing, a pin joined to the fixed hinge, a rotating hinge coupled to the pin, and an arm joined to the rotating hinge at a first end and connected to the flapper proximate a second end;
wherein the biasing member further comprises a spring rod pinned at an end to the fixed hinge and slidably engaged by the flapper at another end, and wherein the compression spring is mounted over the spring rod;
wherein the flapper further comprises a nut connected to the flapper, a bushing attached to the nut, wherein the bushing defines an aperture configured to receive the spring rod and to shoulder the compression spring, and a top attached to the bushing and protruding on a side of the spring rod opposite from the flapper in a direction proximately perpendicular to an axial direction of the spring rod; and
wherein the top is configured to interfere with a discharge pipe connected to an outlet from the housing prior to any interference between the compression spring and the discharge pipe.

16. The apparatus according to claim 13 wherein said check valve apparatus is installed with the flow path in an orientation in which the flow path is vertical to the horizontal.

17. The apparatus according to claim 16, wherein the connector comprises a fixed hinge attached inside the housing, a pin joined to the fixed hinge, a rotating hinge coupled to the pin, and an arm joined to the rotating hinge at a first end and connected to the flapper proximate a second end;
wherein the biasing member further comprises a spring rod pinned at an end to the fixed hinge and slidably engaged by the flapper at another end, and wherein the compression spring is mounted over the spring rod;
wherein the flapper further comprises a nut connected to the flapper, a bushing attached to the nut, wherein the bushing defines an aperture configured to receive the spring rod and to shoulder the compression spring, and a top attached to the bushing and protruding on a side of the spring rod opposite from the flapper in a direction proximately perpendicular to an axial direction of the spring rod; and
wherein the top is configured to interfere with a discharge pipe connected to an outlet from the housing prior to any interference between the compression spring and the discharge pipe.

18. The apparatus according to claim 17, wherein the biasing member and the flapper are configured to cycle for at least six-hundred thousand cycles.

19. A method for operating a biased check valve in a compressor piping system, comprising the steps of:
installing the biased check valve into the compressor piping system in an orientation wherein a flow path, defined by a housing for the biased check valve, is not horizontal;
biasing the check valve to a closed position; and
wherein said step of biasing the check valve is performed internal to the housing of the check valve.

20. The method according to claim 19, wherein said step of biasing the check valve is performed by compressing a flapper of the check valve internal to the housing of the check valve.
